(19) United States
(12) Patent Application Publication
(10) Pub. No.: US 2001/0046318 A1
(43) Pub. Date: Nov. 29, 2001

(54) Compressing image data

(76) Inventors: Suk-Joong Lee, Ichon-shi (KR); Sang-Yeon Kim, Ichon-shi (KR)

Correspondence Address: PILLSBURY WINTHROP LLP, 1600 TYSONS BOULEVARD, MCLEAN, VA, 22102, US

(21) Appl. No.: 09/750,036

(22) Filed: Dec. 29, 2000

(30) Foreign Application Priority Data
Dec. 30, 1999 (KR) 1999-66496

(51) Int. Cl. G06K 9/00; G06K 9/36

(52) U.S. Cl. 382/166

(57) ABSTRACT

Image data fed from an image sensor having a color pixel array by 2 dimensional compression and difference algorithm is disclosed. Firstly, the red, green and blue(R/G/B) color values from the image data extracted; vertical difference color values between current R/G/B color values of a current line and previous R/G/B color values of a previous line are calculated; the vertical difference color values with a predetermined loss value are calculated to obtain quota color values; and the horizontal difference color values between a current quota color value and a previous quota color value are estimated.

### BACKGROUND

1. Field of the Invention

The present invention relates to compressing image data from an image sensor. More particularly, the inventions claimed herein relate to a two (2) dimensional compression algorithm for compressing image data from the image sensor. The algorithm uses line correlation of a pixel array to increase the compression ratio.

2. General Background and Related Art

It is known to use a discrete cosine transformation (DCT) algorithm to compress image data from an image sensor. In fact such algorithms have been adopted as standards by the joint photographic experts group (JPEG) which publishes standards for compressing still image data, moving picture experts group (MPEG) 1, MPEG 2, and H.261/H.263 described in H.320, H.323 and H.324, i.e., an image telecommunication standard of the Institute of Electrical and Electronic Engineers (IEEE).

In order to compress image data using the conventional DCT algorithm, a significant amount of hardware is required, i.e. a number of multipliers and adders/subtracters are required. Since the decoding of the compressed data is, in essence, the reverse of the compression procedure, still more hardware with its attendant space and cost are required for decoding.

In one effort to overcome this problem, the inventor of the claims herein has made inventions set forth in a Korean patent application No. 98-15469 entitled “METHOD AND APPARATUS FOR COMPRESSING IMAGE DATA FED FROM A IMAGE SENSOR WITH A BAYER PATTERN” filed on Apr. 30, 1998.

Specifically, the image data compression arrangement described in that application includes a R/G/B extraction unit 22 that extracts the R/G/B color values for each pixel of image data fed from the image sensor with the bayer pattern. A compression and differential pulse coded modulation (DPCM) unit receives R/G/B color values from the R/G/B extraction 22 and subtracts current R/G/B color values from previous R/G/B color values to generate difference values for compressing the image data. A variable length code compression unit executes a variable length coding (VLC) algorithm for the compressed and differentiated data fed from the compression and DPCM unit based on a statistical result thereof. A data packet unit packetizes the image data fed from the variable length code compression unit in order to estimate the length of data in a receiving end, thereby generating the finally compressed image data.

Since the R/G/B color values between two neighboring pixels are highly-correlated and thereby represented by similar magnitudes with each other, the compression and DPCM unit generates the difference values between the current quota color values and the previous quota color values. The difference values are approximately “0”. The difference values are transmitted to the variable length code compression unit, thereby compressing the data first. In order to output the difference values directly, the variable length code compression unit applies a variable length coding algorithm based on the statistical result thereof to the difference values fed from the compression and DPCM unit, thereby further reducing the data volume.

The compression and DPCM unit have been used to considerably reduce the data volume of color values for the image data fed from the R/G/B extraction unit and performs the compression and difference algorithm on a line basis based on the first R/G/B color values of each line.

FIG. 1, (Prior Art) is a flow chart of a known compression and difference algorithm of the compression and DPCM unit. At step 60, previous quota color values (Rold, Gold, Bold) and previous remainder color values (Rpres, Gpres, Bpres) are initialized with “0” and. At step 62, current color values (Rnow, Gnow, Bnow) are retrieved from the R/G/B extraction unit. At step 64, the current color values (Rnow, Gnow, Bnow) are added to the previous remainder color values (Rpres, Gpres, Bpres), respectively, to generate added color values (Rn, Gn, Bn). At step 66, the added values (Rn, Gn, Bn) are divided by a loss value (LossV) to obtain current quota color values (Rq, Gq, Bq) and current remainder color values (Rres, Gres, Bres). At step 68, difference color values (Rdiff, Gdiff, Bdiff) between the current quota color values (Rq, Gq, Bq) and the previous quota color values (Rold, Gold, Bold) are calculated, respectively. At step 70, the current quota color values (Rq, Gq, Bq) and the current remainder color values (Rres, Gres, Bres) are updated in memory as fresh previous quota color values (Rold, Gold, Bold) and fresh remainder color values, respectively. At step 72, it is determined if the end of line reaches or not. Steps 62 to 70 are repeated until the end of each line of the pixel array. If the end of line reaches, a fresh line is received with the initialization process and steps 60 to 70 are performed. The reason is that there is little correlation between the end color values at the end of each line and the beginning color values at the beginning of another line.

Although an error is generated during transmitting the compressed information to the next processing unit, the range of the error may be limited to the image data for the line itself. Accordingly, the difference color values (Rdiff, Gdiff, Bdiff) between the current quota color values (Rq, Gq, Bq) and the previous quota color values (Rold, Gold, Bold) are fed from the compression and DPCM unit to the variable length code compression unit. The loss value (LossV) represents the pixel image loss ratio during displaying the color values of the pixels fed from the image sensor and it is programmable. At step 64, the current remainder color values (Rres, Gres, Bres) for the current color values, which are obtained by dividing the current color values by the LossV, are added to the next color values, respectively, thereby to reconstruct the compressed image data with a still better image without discarding the remainder color values (Rres, Gres, Bres).

Since, accordingly, there is little image data difference between two neighboring pixels, the compression and DPCM unit performs the compression and difference algorithm on an one dimensional line basis based on the first R/G/B color values of each line, thereby simply compressing the image data. Although, however, the one dimensional compression and difference algorithm is relatively simple, a still higher compression ratio is required.

### SUMMARY

With this background, the claimed inventions feature, at least in part, a method of performing two-dimensional compression of image data from an image sensor on a line and a column basis to obtain a still higher compression ratio. The inventions are described in terms of a method and embrace an algorithm represented by program code stored on a computer readable medium.

According to an exemplary embodiment of the present invention, there is provided a method for compressing image data from an image sensor having a color pixel array. The method includes:

extracting red, green and blue(R/G/B) color values from the image data;

calculating vertical difference color values between current R/G/B color values of a current line and previous R/G/B color values of a previous line;

dividing the vertical difference color values with a predetermined loss value to obtain quota color values;

estimating horizontal difference color values between a current quota color value and a previous quota color value; and

coding the horizontal difference values.

In accordance with another exemplary embodiment of the present invention, there is provided a method for compressing image data fed from an image sensor having a color pixel array. The method includes:

(a) extracting red, green and blue(R/G/B) color values from the image data;

(b) calculating vertical difference values between current R/G/B color values of a current line and previous R/G/B color values of a previous line, respectively;

(c) adding the vertical difference values with previous R/G/B remainder color values to obtain added color values;

(d) dividing the added color values with a predetermined loss value to generate current R/G/B quota color values and current R/G/B remainder color values;

(e) estimating horizontal difference values between the current R/G/B quota color values and previous R/G/B quota color values; and

(f) coding the horizontal difference values.

The inventions also include a computer readable medium having program code stored thereon for carrying out the methods described herein.

### BRIEF DESCRIPTION OF THE DRAWINGS

Exemplary embodiments of the claimed inventions will be explained in detail with reference to the accompanying drawings, wherein:

FIG. 1 is a flow chart explaining the compression and difference operation of a conventional compression and DPCM unit;

FIG. 2 is a schematic diagram of a pixel array with a conventional bayer pattern;

FIG. 3 is a schematic diagram of the R/G/B color values for each pixel shown in FIG. 2 extracted from the R/G/B extraction unit;

FIG. 4 is a flow chart explaining a data compression algorithm, according to the inventions, that performs a two-dimensional compression and difference; and

FIGS. 5A to 5H are schematic diagrams explaining a data compression algorithm in accordance with the present invention.

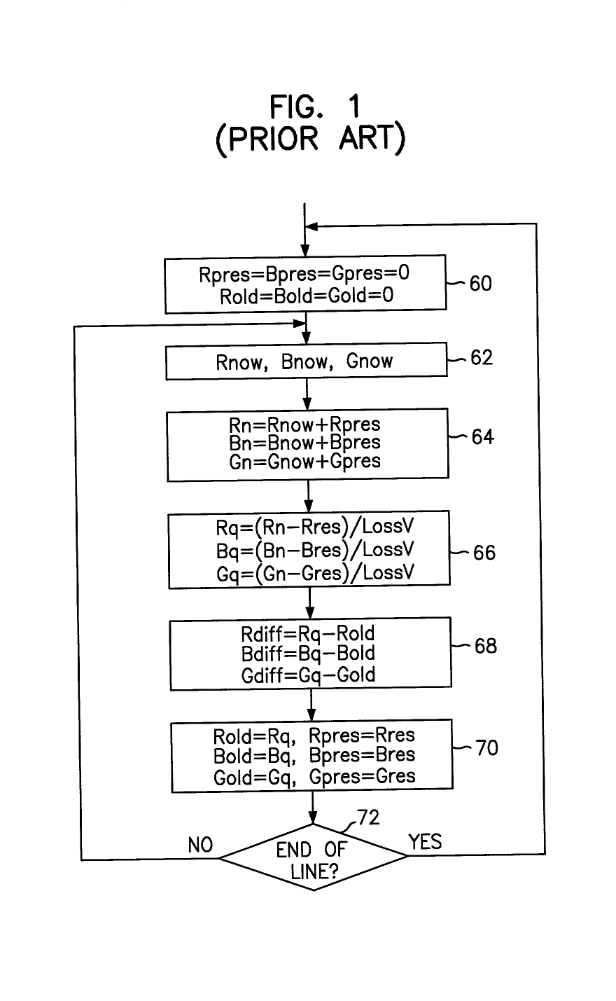

### DETAILED DESCRIPTION

Generally, there are higher correlations between two neighboring pixels in the same line of a pixel array than between random pixels of the array. Also, there is little image data difference between two pixels in the same column of a pixel array. Therefore, a two-dimensional difference and compression algorithm is based on the first R/G/B color values of each line to obtain a higher compression ratio than that of one-dimensional horizontal line-based compression algorithm.

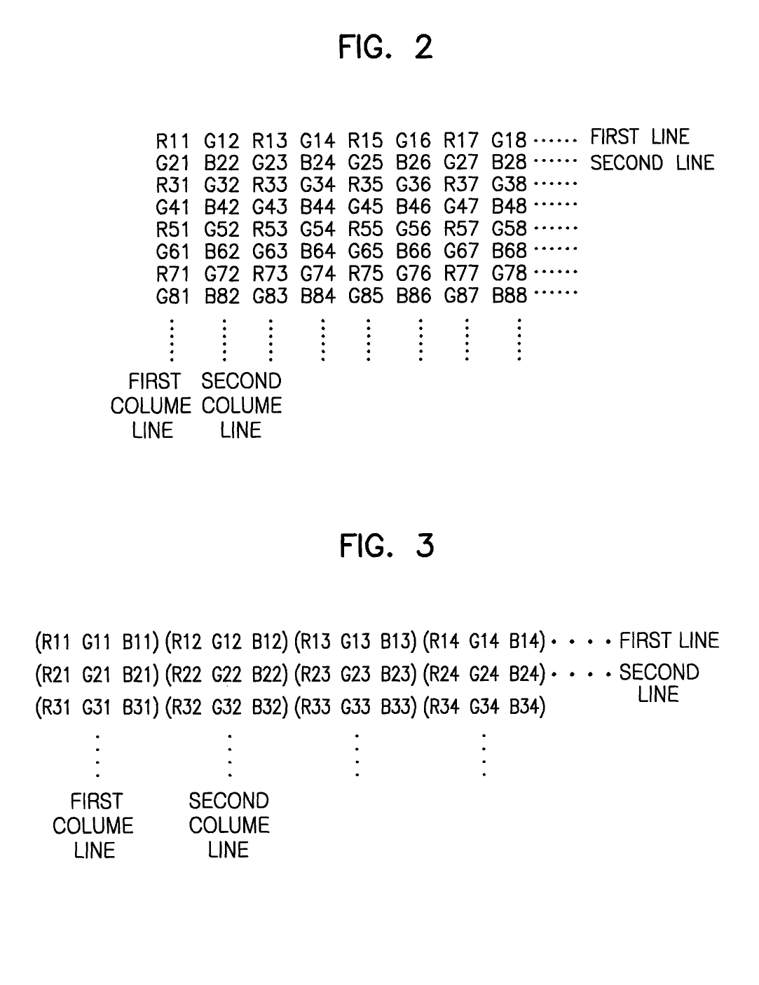

FIG. 2 is a schematic diagram of a pixel array with a conventional bayer pattern. All odd lines in the pixel array have a pattern ‘RGRG’ while all even lines have structured with ‘GRGR’. ‘RGRG’ or ‘GRGR’ represents a color filter covered on the corresponding pixel. In other words, each of the Rs and Gs represents a value of a pixel that is covered with either a red or green filter. The R/G/B information is not obtained directly from each pixel by the image sensor with this bayer pattern as described above. Rather, only a specified color value (R, G, or B) corresponding to the specified color filter covered on the pixel is detected and all R/G/B color values for each pixel are extracted from the specified color value by an R/G/B extraction unit.

FIG. 3 is a schematic diagram of the R/G/B color values for each pixel shown in FIG. 2 extracted from the R/G/B extraction unit. This drawing conceptually illustrates R/G/B color values for all pixels in the pixel array shown in FIG. 2 extracted from the R/G/B extraction unit.

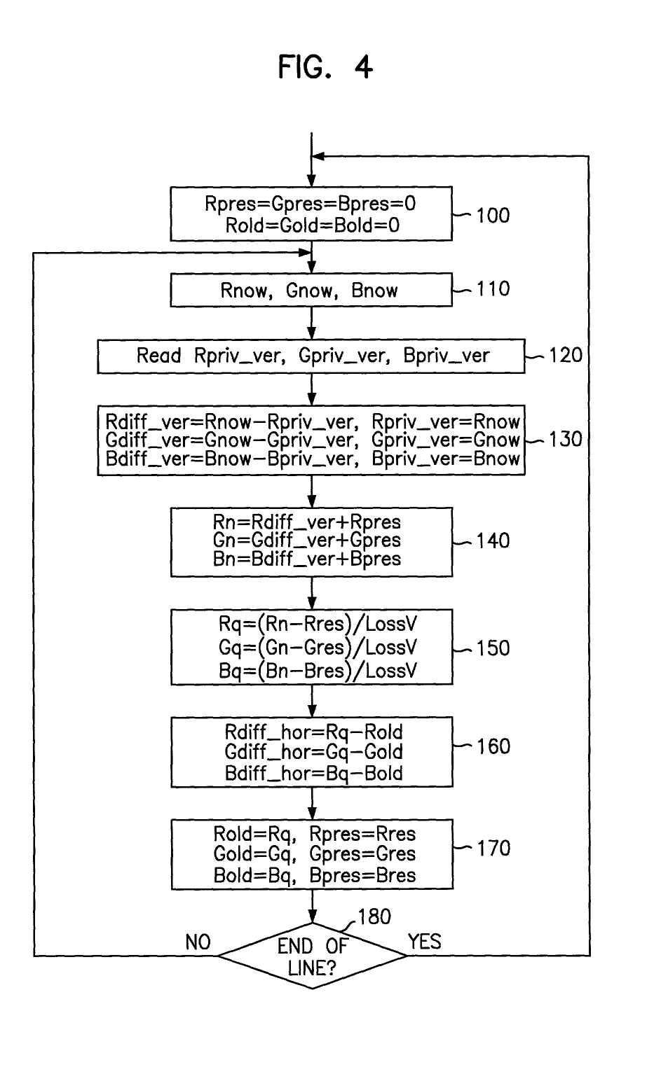

FIG. 4 is a flow chart explaining a data compression algorithm, according to the inventions, that performs a two-dimensional compression and difference. An exemplary method for compressing image data from a first column pixel G21 of the second line shown in FIG. 3 will be specifically presented for a simple illustration.

At step 100, previous quota color values (Rold, Gold, Bold) and previous remainder color values (Rpres, Gpres, Bpres) are initialized with ‘0’. At step 110, the current color values (Rnow, Gnow, Bnow), i.e., (R21, G21, B21) shown in FIG. 3, for the pixel G21 are retrieved from the R/G/B extraction unit. At step 120, the color values (Rpriv_ver, Gpriv_ver, Bpriv_ver), i.e., (R11, G11, B11) shown in FIG. 3, for the first column pixel R11 of the previous line, i.e., the first line, of the pixel G21 are retrieved. At step 130, the vertical difference values (Rdiff_ver, Gdiff_ver, Bdiff_ver) between the current color values (Rnow, Gnow, Bnow), i.e., (R21, G21, B21) shown in FIG. 3, of the pixel G21 and the color values (Rprn_ver, Gpriv_ver, Bpriv_ver), i.e., (R11, G11, B11) shown in FIG. 3, of the pixel R11 are calculated. Then, in order to compress the data of the next line, i.e., the third line, the current color values (Rnow, Gnow, Bnow), i.e., (R21, G21, B21 shown in FIG. 3, are stored into memory as the updated previous line color values (Rpriv_ver, Gpriv_ver, Bpriv_color), respectively.

At step 140, the vertical difference values (Rdiff_ver, Gfdiff_ver, Bdiff_ver) calculated at step 130 are added to the previous remainder color values (Rpres, Gpres, Bpres), respectively. At step 150, the added color values (Rn, Gn, Bn) are divided with a loss value Loss V to obtain the quota color values (Rq, Gq, Bq) and the remainder color values (Rres, Gres, Bres).

At step 160, horizontal difference values (Rdiff_hor, Gdiff_hor, Bdiff_hor) between the current quota color values (Rq, Gq, Bq) and the previous quota color values (Rold, Gold, Bold) are estimated, respectively. At step 170, the current quota color values (Rq, Gq, Bq) and the current remainder color values (Rres, Gres, Bres) are updated into the memory as fresh previous quota color values (Rold, Gold, Bold) and fresh previous remainder color values (Rpres, Gpres, Bpres), respectively. At step 180, it is determined whether the pixel is the end of the line, i.e., the second line, of the pixel array or not. If the pixel is the end of the line, the process goes back to step 100 and, if otherwise, the process goes to step 110.

Steps 110 to 170 are repeated to the end of the line of the pixel array and, if the second line is terminated, the fresh line, i.e., the third line, is received with the initialization and steps 100 to 170 are repeated. That is because the color value of the last pixel of one line is little correlated with that of the first pixel of the neighboring next line. The difference values (Rdiff, Gdiff, Bdiff) between the current quota color values (Rq, Gq, Bq) and the previous quota color values (Rold, Gold, Bold) are fed from the compression and DPCM unit to the variable length code compression unit.

The data compression algorithm in accordance with the present invention as illustrated above has 2 dimensional vertical and horizontal difference calculation and a compression step to enhance the data compression ratio. In the first line, i.e., the first line in FIG. 3, of the pixel array which has no previous line, there can be performed no vertical difference calculation. Accordingly, step for checking if the first line is received or not may be further inserted after step 110 for receiving the current color values (Rnow, Gnow, Bnow) so that only the conventional one dimensional difference operation may be used to compress the data for the first line.

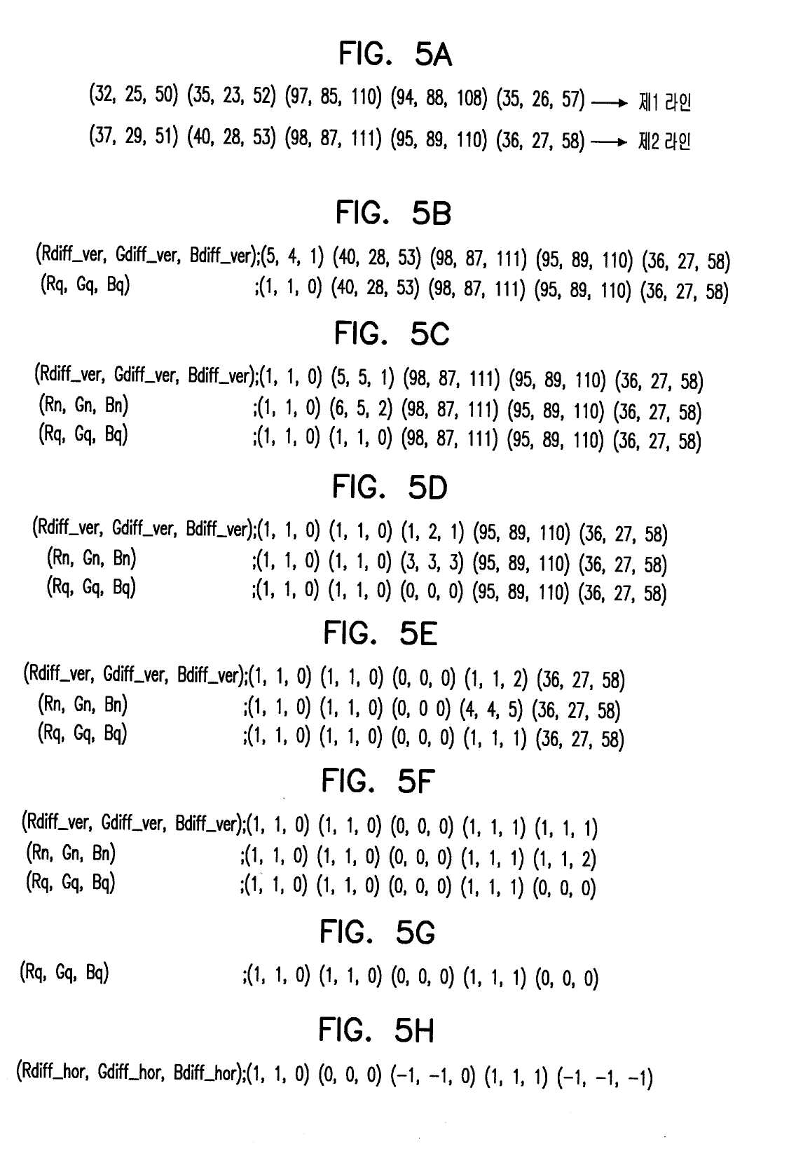

FIGS. 5A to 5H are schematic diagrams explaining an exemplary data compression algorithm in accordance with the present inventions. FIG. 5A shows the corresponding R/G/B color values extracted for every 4 pixels in the R/G/B extraction unit from the image data fed from the pixel array (10 lines×4 lines) with the bayer pattern shown in FIG. 3 by using a 1/4 compression algorithm. The R/G/B color values of the pixels are sequentially displayed. For example, the pixel R11 corresponds to R=32, G=25 and B=50.

FIGS. 5B to 5F, represent data after performing data compression steps shown in FIG. 4 for the R/G/B values extracted from the second line, i.e., the second line of FIG. 5A, in case of loss value “4”. FIG. 5B, illustrates a result obtained from the difference and compression steps for the first R/G/B values (37, 29, 51) of the second line in accordance with the method shown in FIG. 4. The vertical difference values (Rdiff_ver, Gdiff_ver, Bdiff_ver), i.e., (5,4,1) in the step 130 are obtained by vertically subtracting the first R/G/B color values (32, 25, 50) of the first line from the current R/G/B color values (37, 29, 51) so that the first R/G/B quota color values (Rq, Gq, Bq) are (1, 1, 0) and the remainder color values (Rres, Gres, Bres) are (1, 0, 1).

FIG. 5C illustrates a result obtained from the difference and compression steps for the second R/G/B values (40, 28, 53) of the second line in accordance with the method shown in FIG. 4. The vertically difference color values (Rdiff_ver, Gdiff_ver, Bdiff_ver) in the step 130 are obtained as (5, 5, 1) by vertically subtracting the second R/G/B values (35, 23, 52) of the first line from the current R/G/B color values (40, 28, 53) and the second R/G/B color values (Rn, Gn Bn) are obtained as (6, 5, 2) by adding the vertical difference color values (5, 5, 1) to the first R/G/B remainder values (Rres, Gres, Bres). Accordingly, the second R/G/B quota color values (Rq, Gq, Bq) are (1, 1, 0) and the remainder color values (Rres, Gres, Bres) are (2, 1, 2).

FIG. 5D represents a result obtained from the difference and compression operations for the third R/G/B values (98, 87, 111) of the second line in accordance with the flow chart shown in FIG. 4. The vertically difference color values (Rdiff_ver, Gdiff_ver, Bdiff_ver) in the step 130 are obtained as (1, 2, 1) by_vertically subtracting the third R/G/B values (97, 85, 110) of the first line from the current R/G/B color values (98, 87, 111) and the third R/G/B color values (Rn, Gn, Bn) are obtained as (3, 3, 3) by adding the vertical difference color values (1, 2, 1) to the second R/G/B remainder color values (Rres, Gres, Bres). Accordingly, the third R/G/B quota color values (Rq, Gq, Bq) are (0, 0, 0) and the remainder color values (Rres, Gres, Bres) are (3, 3, 3).

FIG. 5E shows a result obtained from the difference and compression operations for the fourth R/G/B values (95, 89, 110) of the second line in accordance with the flow chart shown in FIG. 4. At step 130, the vertical difference color values (Rdiff_ver, Gdiff_ver, Bdiff_ver) are obtained as (1, 1, 2) by vertically subtracting the fourth R/G/B values (94, 88, 108) of the first line from the current R/G/B color values (95, 89, 110) and the fourth R/G/B color values (Rn, Gn, Bn) are obtained as (4, 4, 5) by adding the vertical difference color values (1, 1, 2) to the third R/G/B remainder color values (Rres, Gres, Bres). Accordingly, the fourth R/G/B quota color values (Rq, Gq, Bq) are (1, 1, 1) and the remainder color values (Rres, Gres, Bres) are (0, 0, 1).

FIG. 5F shows a result obtained from the difference and compression operations for the fifth R/G/B values (36, 27, 58) of the second line in accordance with the flow chart shown in FIG. 4. At step 130, the vertical difference color values (Rdiff_ver, Gdiff_ver, Bdiff_ver) are obtained as (1, 1, 1) by vertically subtracting the fifth R/G/B color values (35, 26, 57) of the first line from the current R/G/B color values (36, 27, 58) and the fifth R/G/B color values (Rn, Gn, Bn) are obtained as (1, 1, 2) by adding the vertical difference color values (1, 1, 1) to the fourth R/G/B remainder color values (Rres, Gres, Bres). Accordingly, the fifth R/G/B quota color values (Rq, Gq, Bq) are (0, 0, 0) and the fifth R/G/B remainder color values (Rres, Gres, Bres) are (1, 1, 2).

Referring to FIG. 5G, there are illustrated the R/G/B quota color values (Rq, Gq, Bq) for the extracted color values. FIG. 5H shows a result by performing the final horizontal subtraction for the R/G/B quota color values. In other words, the horizontally difference R/G/B color values (Rdiff_hor, Gdiff_hor, Bdiff_hor) are generated in a sequence of (1, 1, 0), (0, 0, 0), (−1, −1, 0) and so on by horizontally subtracting the previous R/G/B quota color values (Rold, Gold, Bold) from the current R/G/B quota color values (Rq, Gq, Bq). The horizontal difference R/G/B color values (Rdif_hor, Gdiff_hor, Bdiff_hor) are encoded in a variable length code compression unit through the data compression algorithm.

The illustrative embodiment described above used as an example to the second line shown in FIG. 5A while the difference and compression operations for the first line are equal to the conventional horizontal difference operations so that the specific illustrations is eliminated for clarity herein. Since the conventional horizontal difference (Rdiff, Gdiff, Bdiff) for the second R/G/B color values (40, 28, 53) and the third R/G/B color values (98, 87, 111), which have lower horizontal correlation with each other, results in (24, 22, 27), it may be estimated that the difference in accordance with the present invention is still less than the conventional horizontal result, thereby being capable of compressing data easily.

Accordingly, if the horizontal R/G/B difference between two neighboring horizontal pixels in the same line is relatively large while the vertical R/G/B difference between two neighboring vertical pixels in the same column is relatively small, i.e., if the vertical correlation is high, the compression ratio may increase by using the horizontal and vertical difference operation.

By performing two-dimensional compression and difference operations for the image data fed from the image sensor based on the line correlation and the column correlation therebetween in accordance with the present invention, the compression ratio may increase in the image data compression. Specifically, if the horizontal R/G/B difference between two neighboring horizontal pixels in the same line is relatively large while the vertical R/G/B difference between two neighboring vertical pixels in the same column is relatively small, i.e., if the vertical correlation is higher than the horizontal correlation, the compression ratio of the horizontal and vertical difference operation is still larger than that of only the horizontal difference operation.

The inventions have been described for convenience in terms of methods for compressing data. It should be well understood that the methods described herein could be stored as program code on a computer readable medium. A thus encoded medium could be made, sold and used as a stand alone product for use with apparatus that generates data representing image data from a pixel array. While the invention has been shown and described with respect to the preferred embodiments, it will be understood by those skilled in the art that various changes and modifications may be made without departing from the spirit and scope of the claimed inventions.

What is claimed is:

1. A method for compressing image data fed from an image sensor having a color pixel array, comprising:
(a) extracting red, green and blue(R/G/B) color values from the image data;
(b) calculating vertical difference color values between current R/G/B color values of a current line and previous R/G/B color values of a previous line;
(c) dividing the vertical difference color values with a predetermined loss value to obtain quota color values;
(d) estimating horizontal difference color values between a current quota color value and a previous quota color value; and
(e) coding the horizontal difference values.

2. A method according to claim 1, further including before (b):
determining if the image data corresponds to a first line of a frame and, if the image data corresponds to the first line of the frame, proceeding to (c) without performing (b).

3. A method according to claim 1 or claim 2, further comprising before (c):
adding remainder color values obtained from (c) to the vertical difference values.

4. A method according to claim 1 or claim 2, wherein the color pixel array has a bayer pattern.

5. A method according to claim 1, further comprising:
(g) repeating (a) to (d) during one line of the color pixel array and initializing the previous R/G/B color values after completing one line of the color pixel array.

6. A method for compressing image data fed from an image sensor having a color pixel array, comprising:
(a) extracting red, green and blue(R/G/B) color values from the image data;
(b) calculating vertical difference values between current R/G/B color values of a current line and previous R/G/B color values of a previous line, respectively;
(c) adding the vertical difference values with previous R/G/B remainder color values to obtain added color values;
(d) dividing the added color values with a predetermined loss value to generate current R/G/B quota color values and current R/G/B remainder color values;
(e) estimating horizontal difference values between the current R/G/B quota color values and previous R/G/B quota color values; and
(e) coding the horizontal difference values.

7. A method according to claim 6, further comprising:
(f) repeating (a) to (e) during one line of the color pixel array and initializing the previous R/G/B color values after completing one line of the color pixel array.

8. A method according to claim 6, further comprising before (b):
(g) determining if the image data corresponds to a first line of a frame and, if the image data corresponds to the first line of the frame, performing (c) without performing (b).

9. A computer readable medium having program code stored therein which when executed by a computer causes data representing image data from an image sensor having a color pixel array to be compressed by:
(a) extracting red, green and blue(R/G/B) color values from the image data;
(b) calculating vertical difference color values between current R/G/B color values of a current line and previous R/G/B color values of a previous line;
(c) dividing the vertical difference color values with a predetermined loss value to obtain quota color values;
(d) estimating horizontal difference color values between a current quota color value and a previous quota color value; and
(e) coding the horizontal difference values.

10. A computer readable medium according to claim 9, further including before (b):
determining if the image data corresponds to a first line of a frame and, if the image data corresponds to the first line of the frame, proceeding to (c) without performing (b).

11. A computer readable medium according to claim 9 or claim 10, further comprising before (c):
adding remainder color values obtained from (c) to the vertical difference values.

12. A computer readable medium according to claim 9 or claim 10, wherein the color pixel array has a bayer pattern.

13. A computer readable medium according to claim 9, further comprising:
(g) repeating (a) to (d) during one line of the color pixel array and initializing the previous R/G/B color values after completing one line of the color pixel array.

14. A computer readable medium having program code stored therein which when executed by a computer causes data representing image data from an image sensor having a color pixel array to be compressed by:
(a) extracting red, green and blue(R/G/B) color values from the image data;
(b) calculating vertical difference values between current R/G/B color values of a current line and previous R/G/B color values of a previous line, respectively;
(c) adding the vertical difference values with previous R/G/B remainder color values to obtain added color values;
(d) dividing the added color values with a predetermined loss value to generate current R/G/B quota color values and current R/G/B remainder color values;
(e) estimating horizontal difference values between the current R/G/B quota color values and previous R/G/B quota color values; and
(e) coding the horizontal difference values.

15. A computer readable medium according to claim 14, further comprising:
(f) repeating (a) to (e) during one line of the color pixel array and initializing the previous R/G/B color values after completing one line of the color pixel array.

16. A computer readable medium according to claim 14, further comprising before (b):
(g) determining if the image data corresponds to a first line of a frame and, if the image data corresponds to the first line of the frame, performing (c) without performing (b).
